(19) United States
(12) Patent Application Publication
(10) Pub. No.: US 2010/0033992 A1
(43) Pub. Date: Feb. 11, 2010

(54) SWITCHING POWER SUPPLY CONTROLLER AND SEMICONDUCTOR DEVICE USED FOR THE SAME

(75) Inventors: Minoru Fukui, Osaka (JP); Yoshiaki Hachiya, Shiga (JP)

Correspondence Address: STEPTOE & JOHNSON LLP, 1330 CONNECTICUT AVE., NW, WASHINGTON, DC, 20036, US

(73) Assignee: Panasonic Corporation, Osaka (JP)

(21) Appl. No.: 12/500,113

(22) Filed: Jul. 9, 2009

(30) Foreign Application Priority Data
Aug. 6, 2008 (JP) 2008-202487

(51) Int. Cl. H02M 3/335

(52) U.S. Cl. 363/16

(57) ABSTRACT

In the present invention, according to a time from when a switching element 2 is turned on to when the switching element 2 reaches a set overcurrent detection level, an on time correction circuit 15 changes a time from when the switching element 2 reaches the overcurrent detection level to when the switching element 2 is turned off. Thus it is possible to keep constant the peak value of drain current passing through the switching element 2, regardless of an input voltage Vin.

### FIELD OF THE INVENTION

The present invention relates to a switching power supply controller which controls an output voltage by using a switching operation on a DC voltage and supplies the output voltage to a load, and a semiconductor device used for the same.

### BACKGROUND OF THE INVENTION

In the prior art, in order to improve power efficiency in response to lower power consumption, switching power supply controllers have been widely used as the power supplies of home use equipment such as home electrical appliances. The switching power supply controllers have switching power supply control semiconductor devices which control (stabilize) output voltages by using the switching operations of semiconductors (switching elements such as a transistor).

Such a switching power supply controller of the prior art is disclosed in, for example, Japanese Patent Laid-Open No. 2007-166810.

As shown in FIG. 10, the switching power supply controller includes an oscillator 712 for controlling the switching period of a switching element 702, a drain current detection circuit 714 for detecting a drain current for controlling the peak current value of the switching element 702, and a feedback signal control circuit 713 for detecting a state of an output voltage through a photocoupler and so on and controlling the on time of the switching element 702. The drain current detection circuit 714 detects the current value of the switching element 702 which performs a switching operation at a frequency having been determined beforehand in the oscillator 712, so that the peak current of the switching element 702 is controlled by a gate driver 720 through an AND circuit 717, a NOR circuit 718, and an RS flip-flop 719 based on an output signal from an on blanking pulse generating circuit 716 and an output signal from the drain current detection circuit 714. Further, by performing PWM control for changing the on time of the switching element 702 in response to the detection of a state of the output voltage, constant voltage control is performed to keep constant a voltage applied to a load.

As has been discussed, the switching power supply controller disclosed in Japanese Patent Laid-Open No. 2007-166810 keeps constant the output voltage of the controller by controlling the drain current value of the switching element.

However, the switching power supply controller disclosed in Japanese Patent Laid-Open No. 2007-166810 has a problem as will be described below.

In the switching power supply controller shown in FIG. 10, when the switching element 702 has a set current value, the switching operation of the switching element 702 is turned off by the drain current detection circuit 714 of the switching element 702. The inclination of current of the switching element 702 is Vin/L based on an L value and an input voltage Vin of a transformer (not shown).

According to the foregoing expression, the inclination increases with the input voltage Vin.

When the operation of the switching element 702 is turned off from the drain current detection circuit 714 of the semiconductor device, a certain delay time tdoff is generated to allow an element in the circuit to have a delay time. Thus the current peak value of the switching element 702 is Vin/L×tdoff which is a current value delayed by tdoff from a current value having been set in the drain current detection circuit 714.

Thus as shown in FIG. 11, the inclination of current of the switching element 702 changes with an input voltage. Thus in consideration of the delay time for turning off the switching element 702, the peak value of actual drain current varies between a high input voltage and a low input voltage.

Thus considering input voltages worldwide, in the case of a high input voltage, an increase in drain current value causes various phenomena. For example, the ripple voltage of an output terminal increases and the loss of the on resistance of the switching element increases.

Output power to the load changes with fluctuations in ripple voltage. Further, as the loss of on resistance increases, the efficiency of the switching power supply decreases and the self-heating of the switching element increases at a high input voltage.

Thus in consideration of a constant current supplied to a load in the event of characteristic changes occurring in the worldwide use of switching power supplies having similar circuit configurations, it is necessary to change the circuit constant of the controller according to the specifications of switching power supplies corresponding to worldwide input voltages. Thus it is difficult to reduce the cost.

### DISCLOSURE OF THE INVENTION

The present invention has been devised to solve the problem of the prior art. An object of the present invention is to provide a switching power supply controller which can keep constant a current to a load without changing the circuit constant of the controller according to an input voltage range and achieve cost reduction, and a semiconductor device used for the same.

In order to solve the problem, a switching power supply controller of the present invention includes: a switching element for switching a first DC voltage; a control circuit for controlling the switching operation of the switching element to control the switching of the first DC voltage; a converter for outputting a signal obtained by converting the waveform of the first DC voltage in response to the switching operation of the switching element; an output voltage generating section for generating a second DC voltage from the output signal of the converter and supplying power to a load; and an output voltage detection circuit for detecting a change of the second DC voltage and transmitting to the control circuit a feedback signal for controlling the switching operation of the switching element, the control circuit including a feedback signal control circuit for determining the level of current passing through the switching element in response to the feedback signal from the output voltage detection circuit; a drain current detection circuit for generating a signal for turning off the switching element when the current passing through the switching element reaches a level value determined by the feedback signal control circuit; and an on time correction circuit for correcting the on time of the switching element based on an output signal from the drain current detection circuit, wherein the on time correction circuit changes the delay time of an off signal for turning off the switching element, according to a time until the current passing through the switching element reaches an overcurrent detection level after the switching element is turned on.

Further, in a semiconductor device of the present invention used for the switching power supply controller, the switching element and the control circuit are made up of integrated circuits formed on the same semiconductor substrate.

According to the present invention, the peak value of drain current passing through the switching element can be kept constant regardless of an input voltage. Thus it is possible to obtain a power supply with constant output characteristics for worldwide input voltages.

It is therefore possible to keep constant a current to the load without changing the circuit constant of the controller according to an input voltage range and reduce the cost of the controller.

### BRIEF DESCRIPTION OF THE DRAWINGS

FIG. 1 is a circuit diagram showing a structural example of a semiconductor device used for a switching power supply controller according to a first embodiment of the present invention;

FIG. 2 is a circuit diagram showing a structural example of the switching power supply controller according to the first embodiment and the semiconductor device used for the same;

FIG. 3 is a schematic diagram showing an overcurrent detection level of a feedback current in the semiconductor device of the first embodiment;

FIG. 4 is a circuit diagram showing a structural example of an on time correction circuit in the semiconductor device of the first embodiment;

FIG. 5 shows the currents of a switching element at different input voltages in the semiconductor device of the first embodiment;

FIG. 6 is a circuit diagram showing a structural example of a switching power supply controller according to a second embodiment of the present invention and a semiconductor device used for the same;

FIG. 7 is a circuit diagram showing a structural example of a semiconductor device used for a switching power supply controller according to a third embodiment of the present invention;

FIG. 8 is a circuit diagram showing a structural example of a drain current detection circuit in the semiconductor device used for the switching power supply controller of the third embodiment;

FIG. 9 shows the current of a switching element according to a second overcurrent detection level in the semiconductor device used for the switching power supply controller of the third embodiment;

FIG. 10 is a circuit diagram showing a structural example of a semiconductor device according to the prior art; and

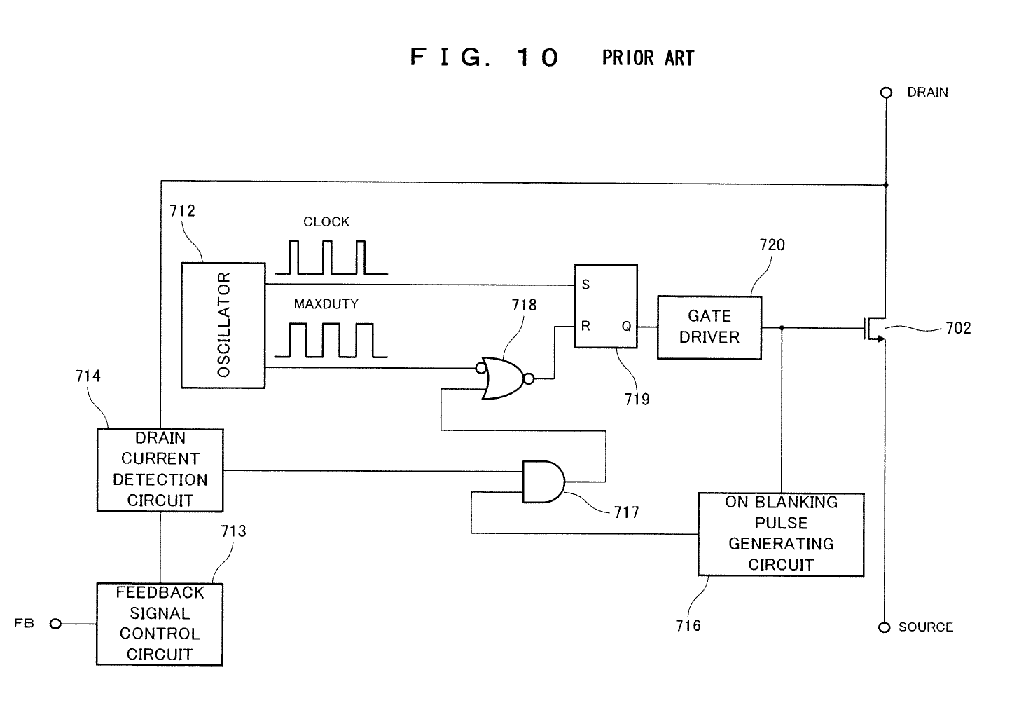

FIG. 11 shows the currents of a switching element at different input voltages in the semiconductor device according to the prior art.

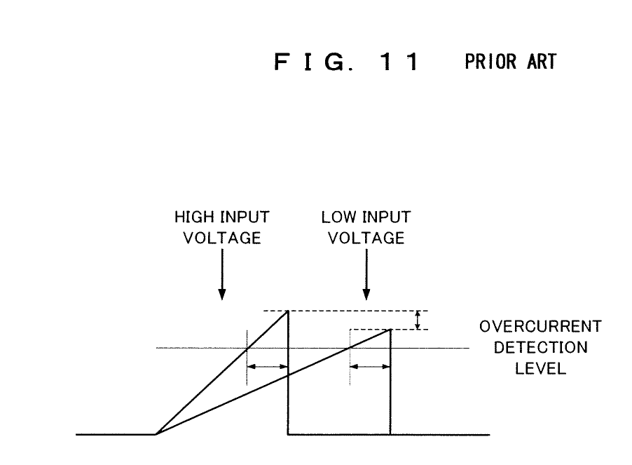

### DESCRIPTION OF THE EMBODIMENTS

The following will specifically describe switching power supply controllers according to embodiments of the present invention and semiconductor devices used for the same with reference to the accompanying drawings.

### First Embodiment

The following will describe a switching power supply controller according to a first embodiment of the present invention and a semiconductor device used for the same.

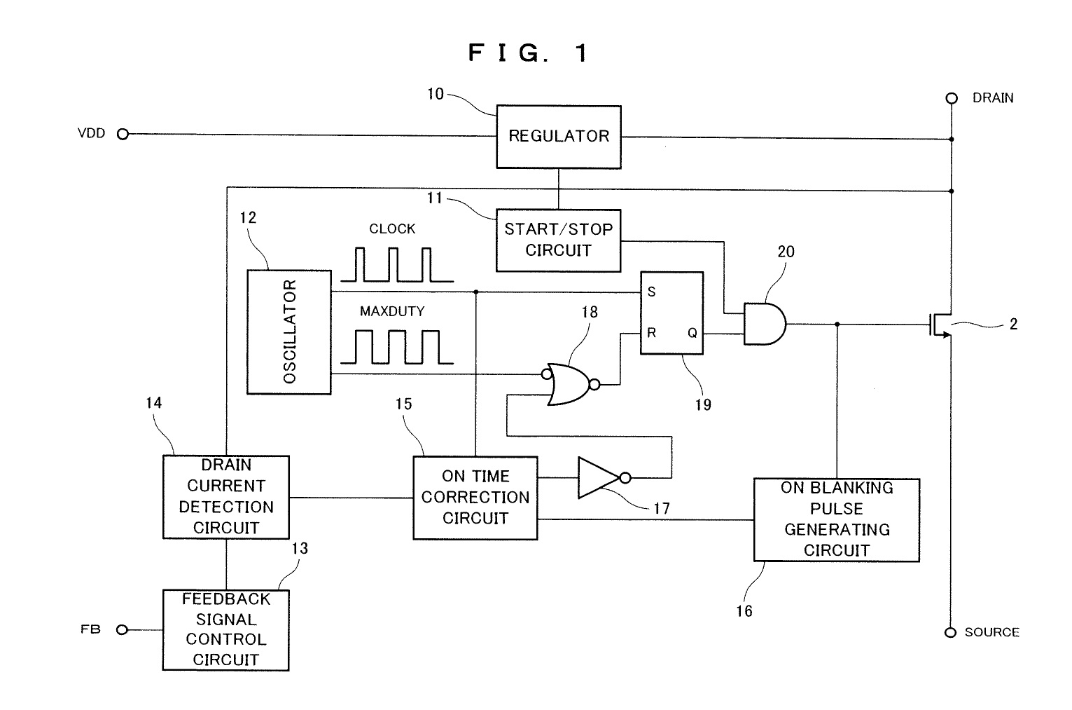

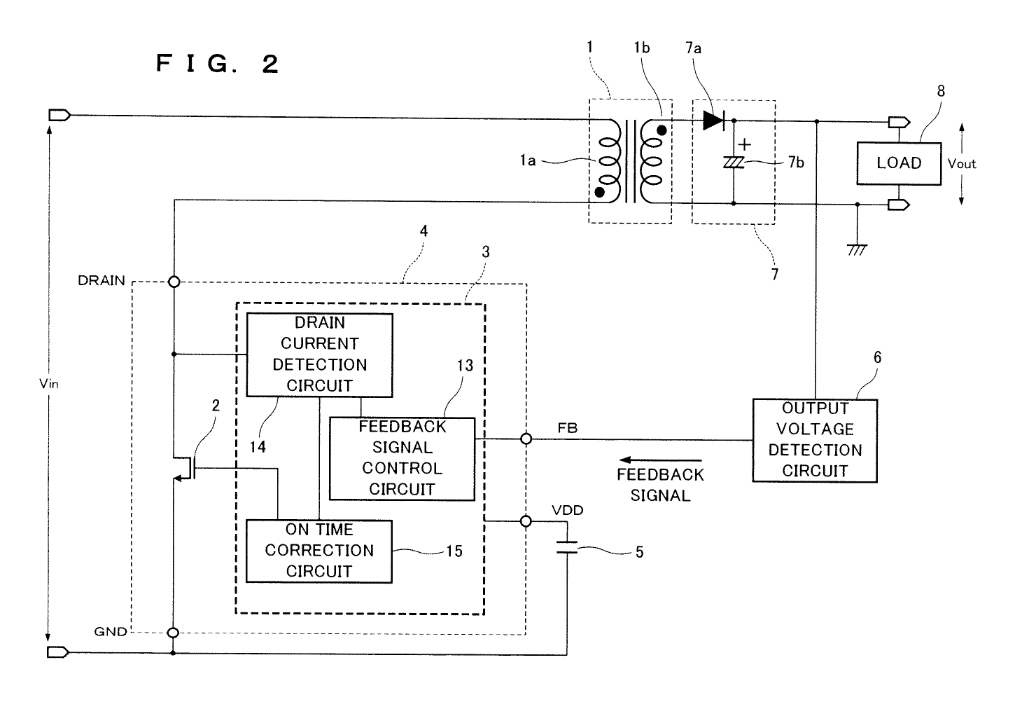

FIGS. 1, 2 and 4 are circuit diagrams showing a structural example of the switching power supply controller according to the first embodiment.

In the switching power supply controller, a transformer 1 has a primary winding 1a and a secondary winding 1b, the transformer 1 acting as a converter for outputting an AC voltage obtained by converting the waveform of an input DC voltage Vin in response to the switching operation of a switching element 2. The primary winding 1a and the secondary winding 1b are opposite in polarity. The switching power supply controller is a flyback controller.

The switching element 2 is connected in series to the primary winding 1a. The control electrode of the switching element 2 undergoes on/off switching control in response to the output signal of a control circuit 3. The control circuit 3 and the switching element 2 are included in a semiconductor device 4, and the switching element 2 made up of a power MOSFET and the like is integrated on the same semiconductor substrate.

A DRAIN terminal is a terminal connected to the junction of the primary winding 1a of the transformer 1 and the switching element 2, that is, the drain of the switching element 2. A GND terminal is a terminal for connecting the source of the switching element 2 and GND of the control circuit 3 to a ground level. The GND terminal is connected to a lower potential terminal of two terminals fed with the input DC voltage Vin. A VDD terminal is a terminal which connects a capacitor 5 and controls the power supply voltage of the control circuit 3 in response to charging from a regulator 10 included in the control circuit 3. An FB terminal is a terminal for inputting a feedback signal (for example, a current and the like from a phototransistor) outputted from an output voltage detection circuit 6, to a feedback signal control circuit 13 of the control circuit 3.

The regulator 10 is connected to the DRAIN terminal of the switching element 2, the VDD terminal, and a start/stop circuit 11. When the input DC voltage Vin is applied to the DRAIN terminal of the switching element 2 through the transformer 1, the regulator 10 supplies a current from the DRAIN terminal to the capacitor 5 through the VDD terminal, and increases an auxiliary power supply voltage VDD. When a VDD terminal voltage reaches a starting voltage, current supply from the DRAIN terminal to the capacitor 5 is stopped. When the VDD terminal voltage decreases below the starting voltage, a current is supplied from the DRAIN terminal to the VDD terminal and thus the VDD terminal voltage increases again.

The start/stop circuit 11 monitors the VDD terminal voltage and controls the oscillation (on) and stop (off) of the switching element 2 according to the VDD terminal voltage. When the VDD terminal voltage reaches the starting voltage, an H level is inputted to one input of an AND circuit 20. When the VDD terminal voltage reaches a stopping voltage, an L level is inputted to the input of the AND circuit 20.

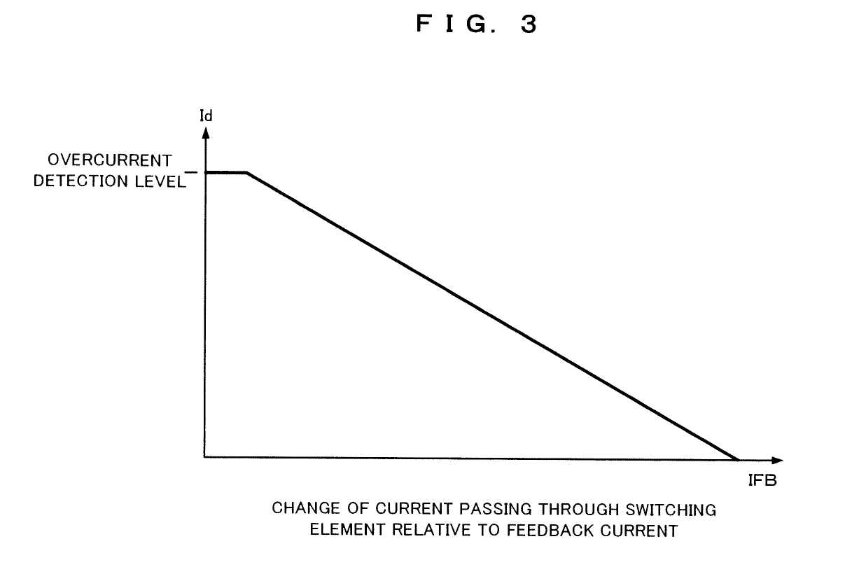

In response to the feedback signal outputted from the output voltage detection circuit 6 and inputted to the FB terminal of the control circuit 3, the feedback signal control circuit 13 determines the level of current passing through the switching element 2 so as to stabilize an output DC voltage Vout at a constant voltage as shown in FIG. 3, and the feedback signal control circuit 13 inputs the current level to a drain current detection circuit 14. An output voltage from the feedback signal control circuit 13 is outputted to the negative side of a comparator 21. When the output voltage Vout increases at a light load, control is performed to reduce a current passing through the switching element 2. When the output voltage Vout decreases at a heavy load, control is performed to increase the current passing through the switching element.

For example, by detecting an on voltage determined by the product of a drain current passing through the switching element 2 and the on resistance of the switching element 2, the drain current detection circuit 14 relatively detects the drain current passing through the switching element 2. Further, the drain current detection circuit 14 outputs a voltage signal proportionate to the drain current to the positive side of the comparator 21. The comparator 21 outputs an H level signal when the drain current on the positive side is equal to the output signal of the feedback signal control circuit 13.

An on blanking pulse generating circuit 16 sets a certain blanking time after the AND circuit (gate driver) 20 outputs a turn-on signal to the switching element 2, so that a capacitive spike current or the like caused by the capacitance of the switching element 2 is not erroneously detected.

An on time correction circuit 15 receives the H-level output signal from the comparator 21 and transmits an H level signal to the reset (R) of an RS flip-flop 19 after a certain delay time. The on time correction circuit 15 will be specifically described in operational description including an example of the circuit configuration.

At start-up, an output signal from the start/stop circuit 11 reaches H level, so that one input of the AND circuit 20 is at H level. Further, the set (S) of the RS flip-flop 19 is fed with an H-level pulse signal in response to a CLOCK signal of an oscillator 12, so that an output (Q) is at H level and the other input of the AND circuit 20 is also fed with an H-level input signal. At this point, since the output signal of the AND circuit 20 is at H level, the switching element 2 is turned on.

After the switching element 2 is turned on, a current corresponding to the feedback signal from the output voltage detection circuit 6 is passed through the switching element 2 by the feedback signal control circuit 13 after the on blanking time. At this point, the H-level output signal of the on time correction circuit 15 is inputted to the reset (R) of the RS flip-flop 19 through an inverter circuit 17 and a NOR circuit 18. Thus the output (Q) switches to L level and one input of the AND circuit 20 is set at L level, so that the switching element 2 is turned off.

When the output of the on time correction circuit 15 is at L level during the maximum on time set by a MAXDUTY signal of the oscillator 12, the signal of the on time correction circuit 15 is inputted to the reset (R) of the RS flip-flop 19 through the NOR circuit 18 in response to the MAXDUTY signal of the oscillator 12. Thus the output (Q) switches to L level and one input of the AND circuit 20 is set at L level, so that the switching element 2 is turned off.

The switching (on/off) operation of the switching element 2 is performed by the foregoing signal processing.

To the secondary winding 1b of the transformer 1, an output voltage generating section 7 made up of a rectifying diode 7a and a capacitor 7b is connected. In response to the switching operation of the switching element 2, an AC voltage induced to the secondary winding 1b by waveform conversion from the input DC voltage Vin in the transformer 1 is rectified and smoothed by the output voltage generating section 7, so that the output DC voltage Vout is generated and is applied to a load 8.

The output voltage detection circuit 6 is made up of, for example, an LED and a Zener diode and the like. The output voltage detection circuit 6 detects the voltage level of the output DC voltage Vout and outputs a feedback signal necessary for allowing the control circuit 3 to control the switching operation of the switching element 2 so as to stabilize the output DC voltage Vout at a predetermined voltage.

In the switching power supply controller, commercial AC power is rectified by the rectifier such as a diode bridge and is smoothed by the input capacitor, so that the AC power is converted to the DC voltage Vin. The DC voltage Vin is supplied to the primary winding 1a of the transformer 1.

The following will describe the operations of the switching power supply controller configured thus as shown in FIGS. 1, 2 and 4 and the semiconductor device used for the same.

When an AC power is inputted to the rectifier such as a diode bridge from a commercial power supply, the power is rectified and smoothed by the rectifier and the input capacitor and is converted to the DC voltage Vin. The DC input voltage Vin is applied to the DRAIN terminal through the primary winding 1a of the transformer 1, and a start-up charging current passes from the DRAIN terminal through the regulator 10 in the control circuit 3 to the capacitor 5 connected to the VDD terminal. When the charging current causes the VDD terminal voltage of the control circuit 3 to reach the starting voltage set by the start/stop circuit 11, control on the switching operation of the switching element 2 is started.

When the switching element 2 is turned on, a current passes through the switching element 2 and a voltage corresponding to the current passing through the switching element 2 is inputted to the positive side of the comparator 21. After the blanking time set by the on blanking pulse generating circuit 16, when a voltage corresponding to the drain current is increased by at least a voltage determined by the negative side of the comparator 21, H level signals are inputted to both inputs of the AND circuit 20. Thus an H level signal is outputted from the AND circuit 20 to the on blanking pulse generating circuit 16. The on blanking pulse generating circuit 16 receives the signal and outputs an H signal to the reset (R) of the RS flip-flop 19 after a certain delay time, and then the switching element 2 is turned off.

When the switching element 2 is turned off, energy having been accumulated in the primary winding 1a of the transformer 1 during the on time of the switching element 2 is transmitted to the secondary winding 1b.

The foregoing switching operation is repeated to increase the output voltage Vout. When the output voltage Vout is not lower than the voltage set by the output voltage detection circuit 6, the output voltage of the feedback signal control circuit 13 decreases with the feedback current fed from the FB terminal of the control circuit 3 as the feedback signal from the output voltage detection circuit 6, and the voltage on the negative side of the comparator 21 decreases. Thus the current passing through the switching element 2 decreases. In this way the on duty of the switching element 2 changes to a proper state.

In other words, at a light load with a small current supplied to the load 8, a current passes through the switching element 2 for a short period. At a heavy load, a current passes through the switching element 2 for a long period.

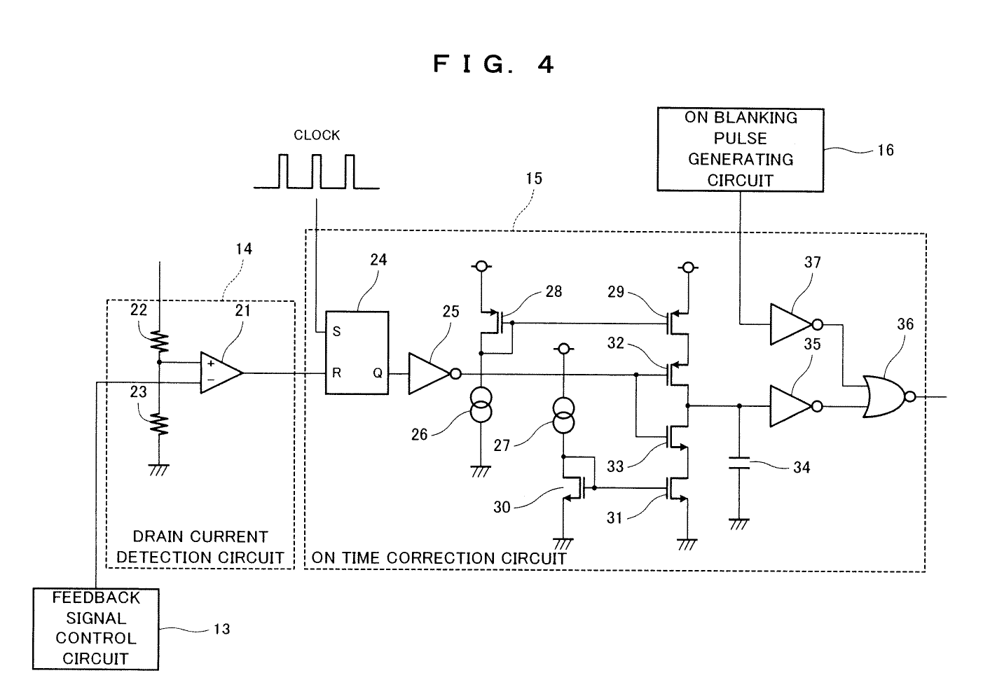

Referring to FIG. 4, the on time correction circuit 15 will be described in detail. FIG. 4 is a circuit diagram showing a structural example of the on time correction circuit 15.

In FIG. 4, reference numeral 24 denotes an RS flip-flop, reference numerals 26 and 27 denote constant current sources, reference numerals 28, 29 and 32 denote P-type MOSFETs, reference numerals 30, 31 and 33 denote N-type MOSFETs, reference numeral 34 denotes a capacitor, reference numerals 25, 35 and 37 denote inverter circuits, and reference numeral 36 denotes a NOR circuit. The P-type MOSFETs 28 and 29 and the N-type MOSFETs 30 and 31 compose mirror circuits.

When the switching element 2 is turned on, an H signal is outputted to the set (S) of the RS flip-flop 24 in response to the CLOCK signal of the oscillator. At this point, the output (Q) of the RS flip-flop 24 switches to an H signal and an L level signal is outputted through the inverter circuit 25. The P-type MOSFET 32 is turned on in response to the L signal, the capacitor 34 is charged by the mirror circuit made up of the constant current source 26 and the P-type MOSFETs 28 and 29, and the voltage increases. The capacitor 34 is connected to the input of the inverter circuit 35. When the voltage of the capacitor 34 is not lower than the threshold value of the inverter circuit 35, the output of the inverter circuit 35 switches from H level to L level and is outputted to the NOR circuit 36. The output of the on blanking pulse generating circuit 16 is inputted to the inverter circuit 37. When the switching element 2 is turned on, L level is outputted from the inverter circuit 37 to the NOR circuit 36. Since the inputs of the NOR circuit 36 are both L level, H level is outputted from the NOR circuit 36.

When the drain current detection circuit 14 detects an overcurrent of the switching element 2, the comparator 21 outputs an H level to the reset (R) of the RS flip-flop 24 to turn off the switching element 2, the output of the RS flip-flop 24 switches to L signal, and an H level signal is outputted through the inverter circuit 25. The N-type MOSFET 33 is turned on in response to the H signal, the capacitor 34 is discharged by the mirror circuit made up of the constant current source 27 and the N-type MOSFETs 30 and 31, and the voltage decreases. The capacitor 34 is connected to the input of the inverter circuit 35. When the voltage of the capacitor 34 is not higher than the threshold value of the inverter circuit 35, the output of the inverter circuit 35 switches from L level to H level and is outputted to the NOR circuit 36. The output of the on blanking pulse generating circuit 16 is inputted to the inverter circuit 37. When the switching element 2 is turned on, L level is outputted from the inverter circuit 37 to the NOR circuit 36. Since the output of the inverter circuit 35 is H level, L level is outputted from the NOR circuit 36.

The effect of the foregoing operation will be discussed below.

The capacitor 34 is charged by turning on the switching element 2. The voltage of the capacitor 34 increases while the switching element 2 is turned on. After that, when the drain current detection circuit 14 detects an overcurrent of the switching element 2, the output of the RS flip-flop 24 is inverted and the output of the NOR circuit 36 is switched. A time from the detection of overcurrent to the switching of the NOR circuit 36 is increased by a time from when the switching element is turned on to when the capacitor 34 is charged. Thus after an overcurrent is detected, a time until the output of the NOR circuit 36 is inverted is increased by the charging time of the capacitor 34.

The foregoing operation is expressed by equations as will be described below.

The capacitor 34 has a voltage V1 from the time the switching element 2 is turned on until the time the drain current detection circuit 14 detects an overcurrent. The voltage V1 is expressed by the following equation:

V1=ton×Iconst1/C

where C is a capacitance value of the capacitor, ton is a time from when the switching element 2 is turned on to when an overcurrent is detected, and Iconst1 is a constant current value for charging the capacitor.

Further, the equation below expresses a time tdoff from when an overcurrent level of the switching element 2 is detected to when the voltage of the capacitor 34 reaches a threshold level V2 where the NOR circuit 36 is inverted.

tdoff=(V1−V2)×C/Iconst2

where Iconst2 is a constant current value for discharging the capacitor 34.

Thus the switching element 2 has a peak current value Ipeak expressed by the following equation:

Ipeak=Vin/L×(ton+tdoff)

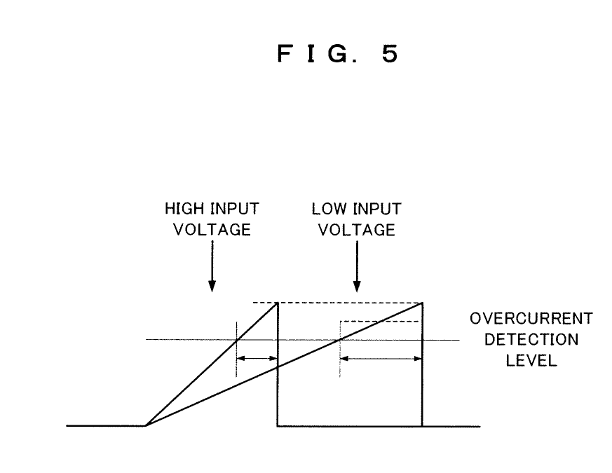

Thus the voltage V1 of the capacitor 34 changes with a change of the time ton from when the switching element 2 is turned on to when an overcurrent is detected, thereby changing the time tdoff until the switching element 2 is turned off. Thus as shown in FIG. 5, the on time of the switching element 2 increases at a low input voltage, so that the peak value of current passing through the switching element 2 can be adjusted to a constant value regardless of an input voltage value.

### Second Embodiment

The following will describe a switching power supply controller according to a second embodiment of the present invention and a semiconductor device used for the same.

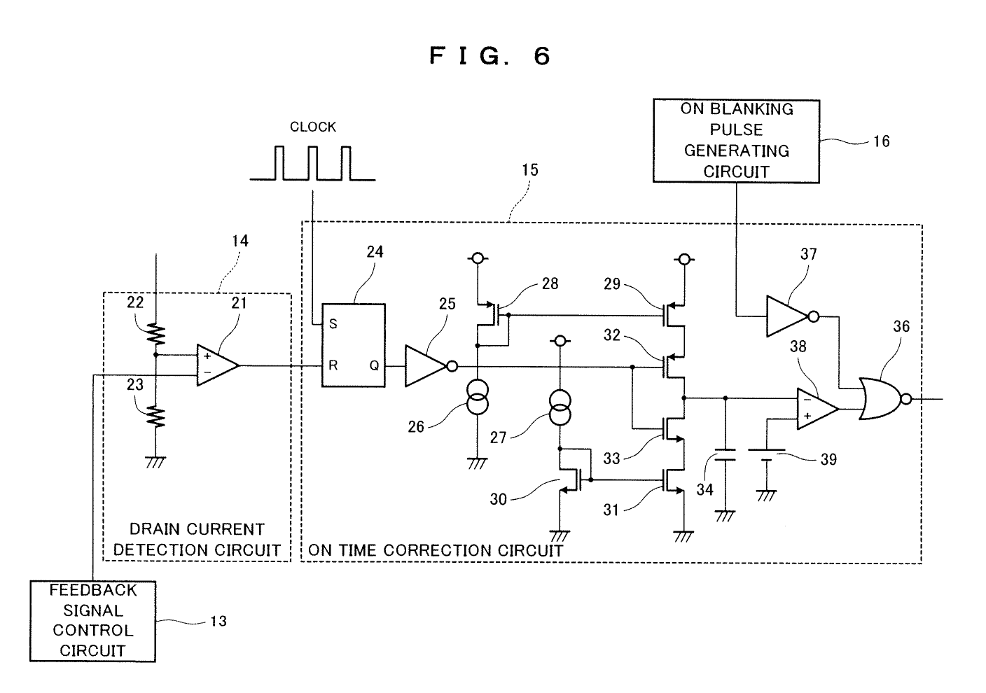

FIG. 6 is a circuit diagram showing a structural diagram of an on time correction circuit 15 of the switching power supply controller according to the second embodiment and the semiconductor device used for the same. As compared with the first embodiment, the threshold value of an inverter circuit 35 changes with a change of a VDD voltage of the inverter circuit 35 and a tdoff time depends upon the VDD voltage. Thus in the second embodiment, the dependence of the on time correction circuit 15 on the VDD voltage is improved. The operational description is similar to that of the first embodiment and thus only different points will be discussed below.

In FIG. 6, reference numeral 24 denotes an RS flip-flop, reference numerals 26 and 27 denote constant current sources, reference numerals 28, 29 and 32 denote P-type MOSFETs, reference numerals 30, 31 and 33 denote N-type MOSFETs, reference numeral 34 denotes a capacitor, reference numeral 25 denotes an inverter circuit, reference numeral 36 denotes a NOR circuit, reference numeral 38 denotes a comparator, and reference numeral 39 denotes a reference voltage source. The P-type MOSFETs 28 and 29 and the N-type MOSFETs 30 and 31 compose mirror circuits.

When a switching element 2 is turned on, an H signal is outputted to the set (S) of the RS flip-flop 24 in response to a CLOCK signal of an oscillator 12. At this point, the output (Q) of the RS flip-flop 24 switches to an H signal and an L level signal is outputted through the inverter circuit 25. The P-type MOSFET 32 is turned on in response to the L signal, the capacitor 34 is charged by the mirror circuit made up of the constant current source 26 and the P-type MOSFETs 28 and 29, and the voltage increases. The capacitor 34 is connected to the negative input of the comparator 38. When the voltage of the capacitor 34 is not lower than the voltage of the reference voltage source 39 connected to the positive side of the comparator 38, the output of the comparator 38 switches from H level to L level and is outputted to the NOR circuit 36. The output of an on blanking pulse generating circuit 16 is inputted to an inverter circuit 37. When the switching element 2 is turned on, L level is outputted from the inverter circuit 37 to the NOR circuit 36. Since the inputs of the NOR circuit 36 are both L level, H level is outputted from the NOR circuit 36.

When a drain current detection circuit 14 detects an overcurrent of the switching element 2, a comparator 21 outputs H level to the reset (R) of the RS flip-flop 24 to turn off the switching element 2, the output of the RS flip-flop 24 switches to an L signal, and an H level signal is outputted through the inverter circuit 25. The N-type MOSFET 33 is turned on in response to the H signal, the capacitor 34 is discharged by the mirror circuit made up of the constant current source 27 and the N-type MOSFETs 30 and 31, and the voltage decreases. The capacitor 34 is connected to the negative input of the comparator 38. When the voltage of the capacitor 34 is not higher than the voltage of the reference voltage source 39 connected to the positive side of the comparator 38, the output of the comparator 38 switches from L level to H level and is outputted to the NOR circuit 36. The output of the on blanking pulse generating circuit 16 is inputted to the inverter circuit 37. When the switching element 2 is turned on, H level is outputted from the inverter circuit 37 to the NOR circuit 36. Since the inputs of the NOR circuit 36 are both H level, L level is outputted from the NOR circuit 36.

The effect of the foregoing operation will be discussed below.

The capacitor 34 is charged by turning on the switching element 2. The voltage of the capacitor 34 increases while the switching element 2 is turned on. After that, when the drain current detection circuit 14 detects an overcurrent of the switching element 2, the output of the RS flip-flop 24 is inverted and the output of the NOR circuit 36 is switched. A time from the detection of overcurrent to the switching of the NOR circuit 36 is increased by a time from when the switching element is turned on to when the capacitor 34 is charged. Thus after an overcurrent is detected, a time until the output of the NOR circuit 36 is inverted is increased by a charging time.

Equations are the same as the first embodiment and thus the explanation thereof is omitted.

### Third Embodiment

The following will describe a switching power supply controller according to a third embodiment of the present invention and a semiconductor device used for the same.

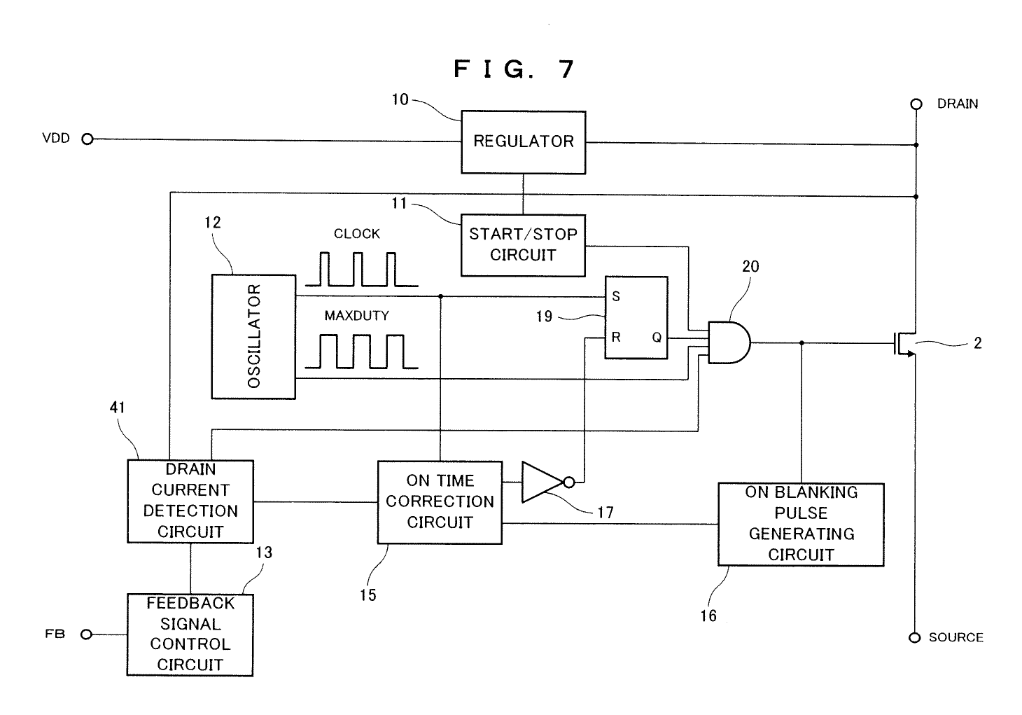

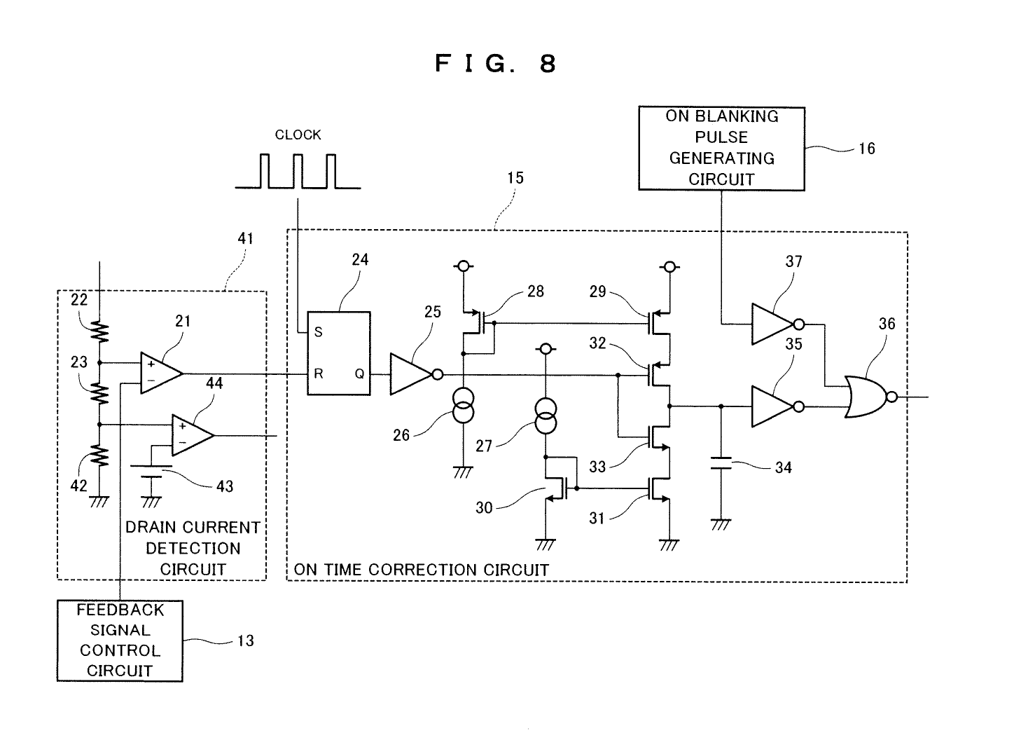

FIGS. 7 and 8 are circuit diagrams showing a structural example of a drain current detection circuit 41 of the switching power supply controller according to the third embodiment and the semiconductor device used for the same. As compared with the first embodiment, as shown in FIG. 8, reference numeral 42 denotes a resistor, reference numeral 43 denotes a reference voltage source, and reference numeral 44 denotes a comparator. In the drain current detection circuit 41, a voltage corresponding to a drain current is applied to the positive side of the comparator 44, the reference voltage source 43 is connected to the negative side of the comparator 44, and the output of the comparator 44 is connected to an AND circuit 20. To the positive side of the comparator 44, a lower voltage is inputted as compared with the positive side of a comparator 21. When an input voltage Vin is low or a delay time is extremely extended, the drain current increases to at least the saturation current of a transformer 1 connected to a semiconductor device 4, so that the drain current cannot be controlled. Thus in the third embodiment, the switching operation of a switching element 2 is turned off by detecting a current not lower than the set drain current. The operational description is similar to that of the first embodiment and thus only different points will be discussed below.

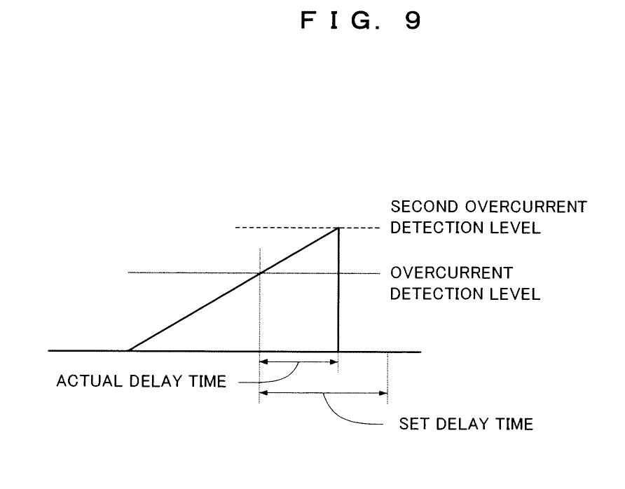

In FIG. 8, when the switching element 2 is turned on, the voltage of the positive side of the resistor 42 is set in response to the passage of drain current by resistors 22, 23 and 42 connected in series. As shown in FIG. 9, the voltage of the positive side of the resistor 42 is not lower than the voltage of the reference voltage source 43 for determining a second overcurrent detection level of a drain current detection level. Thus the output of the comparator 44 switches from H level to L level, so that the output of the AND circuit 20 changes to L level and the switching operation of the switching element 2 is turned off before a delay time as shown in FIG. 9 regardless of the set delay time.

The effect of the foregoing operation will be discussed below.

When the input voltage Vin is low or the delay time is extremely extended in a state of a load, the value of drain current passing through the switching element 2 increases. When the drain current detection circuit 41 detects that a drain current predetermined in the drain current detection circuit 41 passes through the switching element 2, the switching element 2 is turned off regardless of an off delay time generated by an on time correction circuit 15. Thus it is possible to prevent an overcurrent of the switching element 2 or a saturated state of the transformer 1, thereby protecting the switching power supply controller.

Equations are the same as the first embodiment and thus the explanation thereof is omitted.

According to the foregoing circuit configuration, by using a reference voltage source 39 for outputting a predetermined voltage as a reference voltage, tdoff is not changed according to a power supply voltage VDD. Thus it is possible to stably adjust the peak value of current passing through the switching element 2 to a constant value.

In the foregoing explanation, the switching element 2 and the control circuit 3 are disposed on the same substrate. It is not particularly necessary to place the control circuit 3 and the switching element 2 on the same substrate.

In the foregoing explanation, the switching power supply controller of the present invention is an insulated power supply circuit using a transformer as a converter. The switching power supply controller may be a non-insulated power supply circuit using a coil as a converter.

What is claimed is:

1. A switching power supply controller, comprising:
a switching element for switching a first DC voltage;
a control circuit for controlling a switching operation of the switching element to control switching of the first DC voltage;
a converter for outputting a signal obtained by converting a waveform of the first DC voltage in response to the switching operation of the switching element;
an output voltage generating section for generating a second DC voltage from the output signal of the converter and supplying power to a load; and
an output voltage detection circuit for detecting a change of the second DC voltage and transmitting to the control circuit a feedback signal for controlling the switching operation of the switching element,
the control circuit comprising:
a feedback signal control circuit for determining a level of current passing through the switching element in response to the feedback signal from the output voltage detection circuit;
a drain current detection circuit for generating a signal for turning off the switching element when the current passing through the switching element reaches a level value determined by the feedback signal control circuit; and
an on time correction circuit for correcting an on time of the switching element based on an output signal from the drain current detection circuit,
wherein the on time correction circuit changes a delay time of an off signal for turning off the switching element, according to a time until the current passing through the switching element reaches an overcurrent detection level after the switching element is turned on.

2. The switching power supply controller according to claim 1, wherein the on time correction circuit changes the delay time of the off signal to the switching element by charging/discharging a constant current to a capacitor and using an inverter circuit as a determining circuit of the current passing through the switching element.

3. The switching power supply controller according to claim 1, wherein the control circuit comprises an oscillator for oscillating with a predetermined period.

4. The switching power supply controller according to claim 1, wherein the on time correction circuit sets a latch circuit in response to a signal from an oscillator and changes the delay time of the off signal for each switching operation of the switching element.

5. The switching power supply controller according to claim 1, wherein the on time correction circuit changes the delay time of the off signal to the switching element by charging/discharging a constant current to a capacitor and using a comparator as a determining circuit of the current passing through the switching element.

6. The switching power supply controller according to claim 1, wherein a second reference voltage is set in addition to a reference voltage set for the on time correction circuit, and
when the drain current detection circuit detects that a voltage corresponding to a value of the current passing through the switching element is not lower than the second reference voltage, the switching element is turned off regardless of whether the voltage corresponding to the value of current has been detected within the delay time set by the on time correction circuit.

7. A semiconductor device used for the switching power supply controller according to claim 1, wherein the switching element and the control circuit are made up of integrated circuits formed on a same semiconductor substrate.
